(19) United States
(12) Patent Application Publication
(10) Pub. No.: US 2026/0216651 A1
(43) Pub. Date: Jul. 30, 2026

(54) SYSTEM AND METHOD FOR RECOVERYING RESIDUAL PRESSURE AND HEAT BY COUPLING DIRECT AIR CAPTURE WITH COMPRESSED AIR ENERGY STORAGE

(71) Applicant: ZHEJIANG UNIVERSITY, Hangzhou, ZHEJIANG PROVINCE (CN)

(72) Inventors: TAO WANG, HANGZHOU, ZHEJIANG PROVINCE (CN); MENGXIANG FANG, HANGZHOU, ZHEJIANG PROVINCE (CN); WEISHAN LIU, HANGZHOU, ZHEJIANG PROVINCE (CN); XIANG GAO, HANGZHOU, ZHEJIANG PROVINCE (CN); ZHONGYANG LUO, HANGZHOU, ZHEJIANG PROVINCE (CN)

(21) Appl. No.: 19/150,592

(22) PCT Filed: Feb. 5, 2024
(86) PCT No.: PCT/CN2024/075935

§ 371 Date: Jul. 24, 2025

(30) Foreign Application Priority Data
Feb. 16, 2023 (CN) 202310121618.2

(51) Int. Cl. B01D 53/96; B01D 53/04; B01D 53/34; B01D 53/62; B01D 53/82

(52) U.S. Cl. CPC B01D 53/96; B01D 53/0438; B01D 53/343; B01D 53/62; B01D 53/82; B01D 2253/102; B01D 2253/116; B01D 2253/204; B01D 2257/504; B01D 2258/06; B01D 2259/4009

(57) ABSTRACT

The present invention is a system and method of coupling direct air carbon dioxide capture technology with compressed air energy storage technology residual pressure and heat. The system of the present invention includes a compressed-air energy storage system, a residual pressure control system, a residual heat centralized storage and control system and a direct air carbon dioxide capture system. By means of the system and method of the present invention, the residual pressure and heat in the compressed air energy storage technology can be effectively utilized, and operation energy consumption and cost of the direct air carbon dioxide capture system can be reduced. In addition, the system and method of the present invention can utilize intermittent renewable energy for “peak load shaving”, and CO₂ stored by the direct air carbon dioxide capture technology can be used for chemical and biological applications. The present invention features flexible arrangement, and can achieve significant energy savings, and maximize the storage and utilization of renewable energy.

### TECHNICAL FIELD

The present invention relates to the technical field of air carbon dioxide separation and capture by using renewable energy sources, as well as energy conservation and environmental protection, and in particular, it relates to a system and method for recovering residual pressure and heat by coupling direct air carbon dioxide capture with compressed air energy storage technology.

### BACKGROUND TECHNOLOGY

An extreme weather issue is triggered by the global warming phenomenon, which has gradually made people come to realize that the ongoing rise in the atmospheric concentration of carbon dioxide (CO₂) poses a threat to human life and existence. Currently, the concentration of carbon dioxide in atmosphere has reached approximately 417 parts per million (ppm), and it is increasing at a rate of 2 ppm per year. Carbon Capture, Utilization and Storage (CCUS) technology is considered to be one of the most economical and feasible methods for significantly reducing greenhouse gas emissions on a large scale and mitigating future global warming. As a key CCUS technology, the large-scale application of direct air capture (DAC) technology with negative emissions can help to significantly reduce carbon dioxide emissions in the short term and can control atmospheric CO₂ concentration. The large-scale utilization of renewable energy sources is an effective measure to reduce the consumption of fossil energy sources at the source and thus significantly reduce CO₂ emissions. At present, the scale of renewable energy is gradually expanding. Considering the impact on the power grid, the phenomenon of “wind and power curtailment” has occurred in some regions. As a technology for “peak shaving and valley filling” of the power grid, energy storage technology provides a driving force for a large-scale deployment of renewable energy sources.

The energy storage technology can significantly reduce the impact of the intermittent operation of renewable energy sources on the power grid. Currently, energy storage technologies are roughly divided into chemical energy storage, electromagnetic energy storage, and mechanical energy storage. Due to relatively low technical maturity and late research, it is currently challenging for chemical energy storage and electromagnetic energy storage to achieve large-scale applications. The mechanical energy storage mainly includes pumped storage, flywheel energy storage, and compressed air energy storage. It has the largest development scale and the highest technical maturity. The compressed air energy storage utilizes electrical energy from renewable energy sources and the power grid in a valley load period. During the valley period of electricity consumption, high-pressure air compressed to 6 Mpa-10 MPa by a compressor is stored in gas storage facilities such as salt caverns. During the peak period of the electricity consumption, the compressed air is released to drive an expansion device for generating electricity, which is an energy storage system. The compressed air energy storage system has advantages in high storage density, good flexibility, low cost, and a long service life. It is expected to solve the problem of wind power curtailment and achieve large-scale development of renewable energy sources.

On the other hand, the direct air carbon dioxide capture (DAC) technology, which directly reduces CO₂ in the atmosphere, is an effective measure for directly reducing the CO₂ emissions. Currently, the direct air carbon dioxide capture technology mainly comprises a high-temperature chemical absorption method and a low-temperature adsorption method. The working principle of the high-temperature chemical absorption method utilizes an alkaline absorbent that absorbs CO₂ and react with calcium hydroxide to form calcium carbonate precipitation, and at the same time regenerates the alkaline absorbent. Finally, the calcium carbonate is heated to 900° C. for regenerating calcium oxide, which is then used to regenerate calcium hydroxide. In the decomposition process of the calcium carbonate, high-purity carbon dioxide is released. Due to operational complexity and equipment requirements brought about by a high temperature, the low-temperature solid adsorption methods have received more widespread attention and recognition. It utilizes solid adsorbents to adsorb carbon dioxide in air, and then utilizes steam at a certain temperature (below 120° C.) to regenerate adsorbents and desorb high-purity CO₂. However, an ultra-low partial pressure of CO₂ in the air (approximately 400 ppm, i.e. 0.04%) leads to problems such as complex operations in the regeneration process and a large system footprint in the direct air carbon dioxide capture system. More importantly, when there is no natural wind available during the operation of the direct air carbon dioxide capture system, energy required to overcome the gas flow pressure drop (greater than 300 Pa) in an adsorption contact device is extremely huge. The energy consumption of fans for pumping air accounts for as high as 50% to 80% of the total energy consumption for direct air carbon dioxide capture, resulting in an energy cost of the direct air carbon dioxide capture system remaining at a high level.

With the rapid development of energy storage technologies matched with renewable electric energy, the coupling of renewable electric energy storage and CCUS technology has become feasible. To fully leverage the advantages of the direct air carbon dioxide capture system, such as flexible layout and negative carbon emissions, and to improve the energy utilization efficiency of compressed air energy storage systems, it is promising to couple the high-energy-consumption process of the direct air carbon dioxide capture system with the residual pressure and heat of compressed air energy storage system. This is expected to reduce the energy consumption and cost of the direct air carbon dioxide capture system, while improving the energy utilization rate of the compressed air energy storage.

### SUMMARY OF INVENTION

In view of the above problem that the ultra-low CO₂ partial pressure of air in the direct air carbon dioxide capture technology leads to high air supply energy consumption and the performance of adsorbents is greatly affected by humidity, the object of the present invention is to provide a system and method for residual pressure and heat by coupling a direct air carbon dioxide capture technology with a compressed air energy storage technology, which is used to solve the problem of the high fan energy consumption in the direct air carbon dioxide capture system and the fluctuation of the performance of adsorbents affected by humidity.

In the present invention, a system and method for coupling direct air carbon dioxide capture technology with compressed air energy storage technology residual pressure and heat can provide CO₂ for industrial applications or biological applications. Through the coupling of the direct air carbon dioxide capture technology and the compressed air energy storage technology, the present invention effectively reduces fans energy consumption and regeneration energy consumption of the direct air carbon dioxide capture system. In addition, the coupled system can enable the efficient utilization of renewable energy sources, reduce the carbon footprint in capture processes, and achieve negative CO₂ emissions.

Specific technical schemes are as follows:

The system for coupling direct air carbon dioxide capture technology with compressed air energy storage technology residual pressure and heat (hereinafter, it may be briefly referred to as a “coupled system”), comprising a compressed air energy storage system, a residual pressure control system, a residual heat centralized storage and control system, and a direct air carbon dioxide capture system, wherein
the compressed air energy storage system comprises an air drying device, an air induction device, an air compression device, a first heat exchange system, a compressed air storage tank, a second heat exchange system, an expansion device, and a generator connected in sequence;
the direct air carbon dioxide capture system comprises an adsorption/desorption contactor, a CO₂ compression device, a third heat exchange system, and a CO₂ high-pressure liquefaction tank connected in sequence;
the air inlet end of the residual pressure control system is connected to the air outlet end of the air induction device through a first DAC air passage and to the air outlet end of the expansion device through a second DAC air passage; the air outlet end of the residual pressure control system is connected to the adsorption/desorption contactor; and a heat exchanger is provided inside the residual pressure control system; and
the residual heat centralized storage and control system is connected to the first heat exchange system through a first heat storage pipeline to form an air compression heat recovery circulation pipeline, is connected to the second heat exchange system through a first heat supply pipeline to form a heated compressed air circulation pipeline, is connected to the adsorption/desorption contactor through a second heat supply pipeline to form a CO₂ desorption circulation pipeline, and is connected to the third heat exchange system through a second heat storage pipeline to form a CO₂ compression heat recovery circulation pipeline; and the residual heat centralized storage and control system is connected to the heat exchanger in the residual pressure control system through a third heat supply pipeline to form a hot air circulation pipeline for regulating a temperature of air passing through the residual pressure control system.

Preferably, the heat recovered by the air compression heat recovery circulation pipeline and the CO₂ compression heat recovery circulation pipeline is supplied to the heated compressed air circulation pipeline, the CO₂ desorption circulation pipeline and the hot air circulation pipeline.

In a preferred example, the residual heat centralized storage and control system comprises a normal-temperature heat storage tank, a medium-temperature heat storage tank and a high-temperature heat storage tank, which are utilized to receive and store the heat recovered by the air compression heat recovery circulation pipeline and the CO₂ compression heat recovery circulation pipeline, wherein
the temperature range of the normal-temperature heat storage tank is 5° C. to 60° C., and the normal-temperature heat storage tank is connected to the third heat supply pipeline to provide a stable heat source for the residual pressure control system and regulate the temperature of air required for adsorption;
the temperature range of the medium-temperature heat storage tank is 70° C. to 150° C., and the medium-temperature heat storage tank is connected to the first heat supply pipeline and the second heat supply pipeline to provide heat required for adsorbents regeneration of the adsorption/desorption contactor and the second heat exchange system;
the temperature range of the high-temperature heat storage tank is 160° C. to 250° C., and the high-temperature heat storage tank is connected to the first heat supply pipeline to provide heat for the second heat exchange system.

Preferably, the medium in the first heat supply pipeline, the second heat supply pipeline and the third heat supply pipeline are each independently at least one of air, water, steam and oil.

In a preferred example, a pressure relief device and an air distribution device are also provided inside the residual pressure control system to match the gas pressure and gas flow of the adsorption/desorption contactor.

Preferably, the gas parameter conditions at the outlet end of the residual pressure control system comprise: the pressure range of 1.01 bar to 4.01 bar, the humidity range of 10% RH to 60% RH, and the temperature range of 5° C. to 40° C.

Preferably, carbon dioxide adsorbents in the adsorption/desorption contactor is at least one of activated carbon, molecular sieve, solid-state amine, quaternary ammonium compounds, and metal-organic frameworks, and a regeneration manner thereof comprises temperature swing adsorption, moisture swing adsorption, pressure swing adsorption, or electrochemical regeneration.

The present invention also provides a method for residual pressure and heat by coupling a direct air carbon dioxide capture technology with a compressed air energy storage technology, wherein the system of coupling a direct air carbon dioxide capture technology with a compressed air energy storage technology residual pressure and heat described as above is matched with renewable energy;
the method comprises the following two operation manners:
operation mode 1: when the renewable energy is abundant, the compressed air energy storage system stores air; after the air enters the air drying device and the air induction device, a part of the air is compressed by the air compression device and then stored in the compressed air storage tank, and the heat released in an air compression process is stored in the residual heat centralized storage and control system through the air compression heat recovery circulation pipeline in the first heat exchange system; the other part of the air enters the adsorption/desorption contactor through the first DAC air passage and the residual pressure control system, and is discharged after CO₂ is adsorbed and removed by adsorbents in the adsorption/desorption contactor; the second heat supply pipeline provides humidity and/or temperature conditions required for adsorbents to desorb CO₂ in the adsorption/desorption contactor; the desorbed CO₂ is compressed by the CO₂ compression device and then stored in the CO₂ high-pressure liquefaction tank; and the heat released in the CO₂ compression process is stored in the residual heat centralized storage and control system through the CO₂ compression heat recovery circulation pipeline in the third heat exchange system; and
operation mode 2: when the renewable energy is insufficient, the compressed air stored in the compressed air storage tank is heated by the second heat exchange system and then enters the expansion device to do work, which is used for the generator to generate electricity; after doing work, air with a stable humidity, temperature and pressure enters the adsorption/desorption device through the second DAC air passage and the residual pressure control system, and is discharged after CO₂ is adsorbed and removed by adsorbents in the adsorption/desorption contactor; the second heat supply pipeline provides humidity and/or temperature conditions required for adsorbents to desorb CO₂ in the adsorption/desorption contactor; the desorbed CO₂ is compressed by the CO₂ compression device and then stored in the CO₂ high-pressure liquefaction tank; and the heat released in the CO₂ compression process is stored in the residual heat centralized storage and control system through the CO₂ compression heat recovery circulation pipeline in the third heat exchange system.

Preferably, when the air temperature is relatively low, such as in winter, the air passing through the residual pressure control system may be heated through the hot air circulation pipeline and the heat exchanger.

In the present invention, a system and method for coupling a direct air carbon dioxide capture technology with a compressed air energy storage technology residual pressure and heat relates to processes as follows:
1. Drying process: when the air humidity is high, the relatively humid air is passed through the air drying device to reduce its relative humidity to a lower level, providing the air source with controllable humidity for the compressed air energy storage system and the direct air carbon dioxide capture system. Desiccants can be arranged in the air drying device. The desiccants comprise calcium chloride, silica gel, calcium sulfate, activated alumina, etc., which can reduce the relative humidity of air to 10% RH-60% RH.
2. Air compression energy storage process: when the power generation from the renewable energy source is abundant, the compressed air energy storage system compresses the dried air in the air compression device; and after being cooled by the first heat-exchange system, the high-pressure air is stored in the compressed air storage tank.
3. Compressed air expansion process: when the power generation from the renewable energy source is insufficient, the compressed air stored in the compressed air energy storage system is heated by the second heat exchange system and then enters the expansion device to do work, driving the generator to generate electricity. Preferably, the air pressure at the outlet of the expansion device is 1.01 bar-4.01 bar, the humidity ranges from 10% RH-60% RH, and the temperature is 5° C.-40° C.
4. Regulation process of the residual pressure control system: the air pressure, humidity and temperature provided by the air induction device and the compressed air energy storage system is regulated to make them within the parameters required by the direct air carbon dioxide capture system, and then the air is introduced into the direct air carbon dioxide capture system; at the same time, the pressurized air is rationally distributed to a plurality of adsorption/desorption contactors of the direct air carbon dioxide capture system, and an air induction (flow) device is arranged to adjust the air supply volume to the direct air carbon dioxide capture system.
5. Controlling the gas temperature by the residual heat centralized storage and control system: the heat released and then stored during the operation of the compressed air energy storage system and the direct air carbon dioxide capture system is supplied to the compressed air through the second heat exchange system, and the heated compressed air is introduced into the expansion device to do work; and when the outside temperature is low, a part of the heat stored in the residual heat centralized storage and control system is utilized to heat the air in the residual pressure control system, and the heated air is introduced into the low and medium temperature adsorption/desorption contactors; when adsorbents are saturated with adsorption, a part of the heat stored in the residual heat centralized storage and control system is used to regenerate adsorbents in the adsorption/desorption contactor and CO₂,
wherein the heat generating process of the coupled system comprises heat storage in the first heat exchange system after the air compression device and heat storage in the third heat exchange system after the CO₂ compression device,
wherein heat supply objects of the coupled system comprise the residual pressure control system of the coupled system that requires a normal temperature, the second heat exchange system that requires a medium and high temperature and the low and medium temperature adsorption/desorption contactor.
6. CO₂ adsorption process: when the renewable energy is abundant, the compressed air expansion process is suspended, the dry air pumped by the air drying device and the air induction device through the first DAC air passage is introduced into the residual pressure control system to control the pressure and temperature, and then enters the adsorption/desorption contactors; or when the renewable energy is insufficient, the compressed air expansion process is started, and the compressed air with residual pressure after doing work in the expansion device is introduced into the adsorption/desorption contactors after passing through the residual pressure control system; the air after adsorption is discharged from the other side of the adsorption/desorption contactors, and adsorbents in the device undergoes the process of adsorbing CO₂. The adsorbents can be in solid form, comprising alkaline ion-exchange resins, quaternary ammonium polymers, quaternary phosphonium polymers, amino-loaded molecular sieves, amino-loaded metal-organic frameworks, amino-loaded activated carbon, etc., which are arranged in a form of particles or membranes.
7. Adsorbents desorption and regeneration process: the humidity swing or temperature swing regeneration method can be used; the heat stored in the residual heat centralized storage and control system is utilized; and warm water or steam at a certain temperature is used to regenerate the adsorption material and release high concentration CO₂ at the same time. For the humidity swing regeneration, spraying or atomizing to moisten adsorbents can be selected to realize CO₂ regeneration, and the temperature of the regeneration water is 20° C.-60° C.; and for temperature swing regeneration, steam at 80° C.-120° C. can be selected to regenerate adsorbents and release CO₂.

After the adsorbents desorption and regeneration process is completed, a next adsorption cycle begins; adsorbents in the adsorption/desorption contactors is uniformly purged with pressurized air to carry out the direct air carbon dioxide capture and CO₂ regeneration processes.
8. Compression process of the CO₂ compression device: high purity CO₂ is compressed by the compression device and stored in the CO₂ high-pressure liquefaction tank.

Compared with the prior art, the beneficial effects of the present invention are as follows:

By means of the coupled system, the residual pressure and heat in the compressed air energy storage technology can be effectively utilized, and the operation energy consumption and cost of a direct air carbon dioxide capture system can be reduced. In addition, the coupled system can utilize intermittent renewable energy for “peak load shaving”, and CO₂ stored by the direct air carbon dioxide capture technology can be used for chemical and biological applications. The present invention features flexible arrangement, can achieve significant energy savings, and maximize the storage and utilization of renewable energy.

In the new method of residual pressure utilization, the pressurized air in the compressed air energy storage system can serve as a high quality air source for the direct air carbon dioxide capture system; and the residual pressure control system provides air with a stable pressure, reducing the energy consumption of fans in the direct air carbon dioxide capture system (which accounts for approximately 50% to 80% of the total energy consumption).

In the new method of residual pressure utilization, the direct air carbon dioxide capture system can be supplied with air of stable temperature and humidity by the residual pressure control system. This ensures that adsorbents in the air carbon dioxide capture system are not affected by the air humidity, maintaining high adsorption performance and stability. The cyclic adsorption performance can be improved by 20% to 50%. In addition, the air with the stable temperature enables the direct air carbon dioxide capture system to operate throughout the year without being affected by the air temperature, regardless of cold weather in cold regions.

The air compression device and the CO₂ compression device in the coupled system can achieve further coupling or sharing, and the first heat exchanger system and the third heat exchange system can achieve partial coupling or sharing. Further coupling can reduce the number of required devices or the need for backups in the system, thereby reducing the cost of the coupled system.

### BRIEF DESCRIPTION OF THE DRAWINGS

FIG. 1 is a schematic diagram of the system and method for recovering residual pressure and heat by coupling direct air carbon dioxide capture with compressed air energy storage of the present invention;

FIG. 2 is a schematic structural diagram of the residual pressure control system.

### DETAILED DESCRIPTION OF THE EMBODIMENTS

The present invention is further described below in conjunction with accompanying drawings and its specific embodiments. It should be understood that these embodiments are only used to illustrate the present invention and not to limit the scope of the present invention. For operation methods in the following embodiments where specific conditions are not specified, they are usually carried out according to conventional conditions or in accordance with conditions recommended by manufacturers.

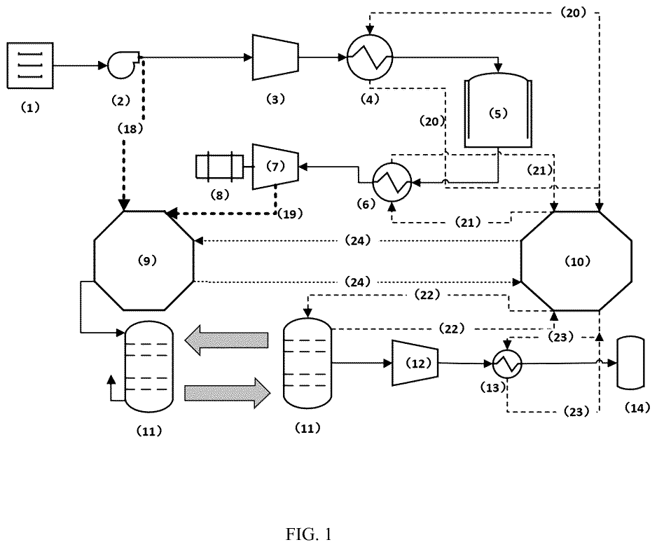

As shown in FIG. 1, a system coupling direct air carbon dioxide capture technology with compressed air energy storage technology residual pressure and heat by, comprising a compressed air energy storage system, a residual pressure control system 9, a residual heat centralized storage and control system 10, and a direct air carbon dioxide capture system.

The compressed air energy storage system comprises an air drying device 1, an air induction device 2, an air compression device 3, a first heat exchange system 4, a compressed air storage tank 5, a second heat exchange system 6, an expansion device 7, and a generator 8 connected in sequence.

The direct air carbon dioxide capture system comprises an adsorption/desorption contactor 11, a CO₂ compression device 12, a third heat exchange system 13, and a CO₂ high-pressure liquefaction tank 14, all of which are connected in sequence.

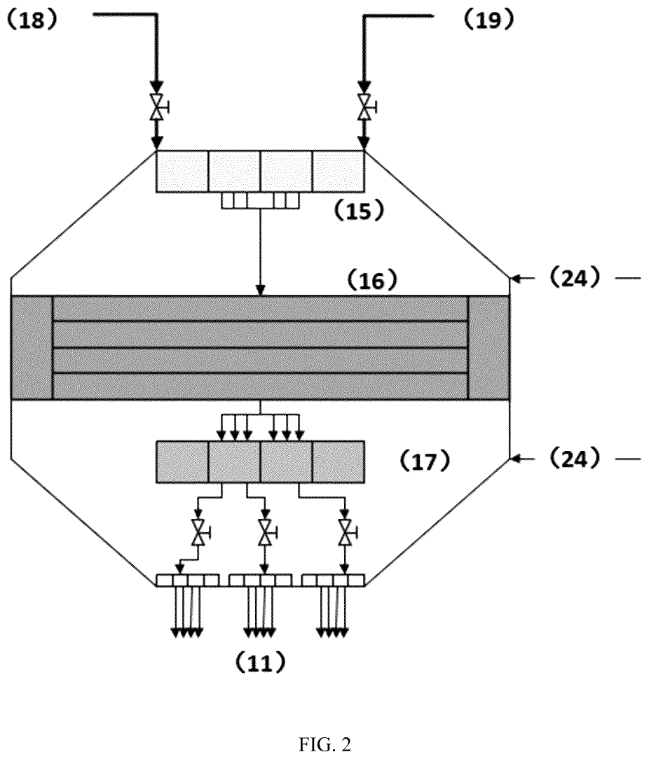

An air inlet end of the residual pressure control system 9 is connected to an air outlet end of the air induction device 2 through a first DAC air passage 18 and to an air outlet end of the expansion device 7 through a second DAC air passage 19; and an air outlet end of the residual pressure control system 9 is connected to the adsorption/desorption contactor 11. As shown in FIG. 2, a pressure relief device 15, a heat exchanger 16 and an air distribution device 17 are arranged successively along a gas flow direction inside the residual pressure control system 9 to match the air pressure and air volume with the adsorption/desorption contactor 11.

The residual heat centralized storage and control system 10 is connected to the first heat exchange system 4 through a first heat storage pipeline 20 to form an air compression heat recovery circulation pipeline, is connected to the second heat exchange system 6 through a first heat supply pipeline 21 to form a heated compressed air circulation pipeline, is connected to the adsorption/desorption contactor 11 through a second heat supply pipeline 22 to form a CO₂ desorption circulation pipeline, and is connected to the third heat exchange system 13 through a second heat storage pipeline 23 to form a CO₂ compression heat recovery circulation pipeline; and the residual heat centralized storage and control system 10 is connected to the heat exchanger in the residual pressure control system 9 through a hot air supply pipeline 24 to form a hot air circulation pipeline for regulating a temperature of air passing through the residual pressure control system 9.

Heat recovered by the air compression heat recovery circulation pipeline and the CO₂ compression heat recovery circulation pipeline is used to be supplied to the heated compressed air circulation pipeline, the CO₂ desorption circulation pipeline and the hot air circulation pipeline.

The residual heat centralized storage and control system 10 comprises a normal-temperature heat storage tank, a medium-temperature heat storage tank and a high-temperature heat storage tank, which are used to receive and store the heat recovered by the air compression heat recovery circulation pipeline and the CO₂ compression heat recovery circulation pipeline.

The temperature range of the normal-temperature heat storage tank is 5° C. to 60° C., and the normal-temperature heat storage tank is connected to the hot air supply pipeline 24 to provide a stable heat source for the residual pressure control system 9 and to regulate the air temperature required for direct air carbon dioxide adsorption.

The temperature range of the medium-temperature heat storage tank is 70° C. to 150° C., and the medium-temperature heat storage tank is connected to the first heat supply pipeline 21 and the second heat supply pipeline 22 to provide heat required for adsorbents regeneration of the adsorption/desorption contactor 11 and the second heat exchange system 6; and the temperature range of the high-temperature heat storage tank is 160° C. to 250° C., and the high-temperature heat storage tank is connected to the first heat supply pipeline 21 to provide heat for the second heat exchange system 6.

Medium in the first heat supply pipeline and the second heat supply pipeline is each independently at least one of water, steam and oil.

In a method for residual pressure and heat by coupling a direct air carbon dioxide capture technology with a compressed air energy storage technology, the system for residual pressure and heat by coupling a direct air carbon dioxide capture technology with a compressed air energy storage technology described as above is matched with renewable energy;
The method comprises the following two operation manners:
operation mode 1: when the renewable energy is abundant, the compressed air energy storage system stores air; after the air enters the air drying device 1 and the air induction device 2, a part of the air is compressed by the air compression device 3 and then stored in the compressed air storage tank 5, and the heat released in an air compression process is stored in the residual heat centralized storage and control system 10 through the air compression heat recovery circulation pipeline in the first heat exchange system 4; the other part of the air enters the adsorption/desorption contactor 11 through the first DAC air passage 18 and the residual pressure control system 9, and is discharged after CO₂ is adsorbed and removed by an adsorbents in the adsorption/desorption contactor 11; the second heat supply pipeline 22 provides humidity and/or temperature conditions required for adsorbents to desorb CO₂ in the adsorption/desorption contactor 11; the desorbed CO₂ is compressed by the CO₂ compression device 12 and stored in the CO₂ high-pressure liquefaction tank 14; and the heat released in a CO₂ compression process is stored in the residual heat centralized storage and control system 10 through the CO₂ compression heat recovery circulation pipeline in the third heat exchange system 13; and
operation mode 2: when the renewable energy is insufficient, compressed air stored in the compressed air storage tank 5 is heated by the second heat exchange system 6 and then enters the expansion device 7 to do work, which is utilized for the generator 8 to generate electricity; after doing work, air with a stable humidity, temperature and pressure enters the adsorption/desorption device 11 through the second DAC air passage 19 and the residual pressure control system 9, and is discharged after CO₂ is adsorbed and removed by adsorbents in the adsorption/desorption contactor 11; the second heat supply pipeline 22 provides humidity and/or temperature conditions required for adsorbents to desorb CO₂ in the adsorption/desorption contactor 11; the desorbed CO₂ is compressed by the CO₂ compression device 12 and stored in the CO₂ high-pressure liquefaction tank 14; and the heat released in a CO₂ compression process is stored in the residual heat centralized storage and control system 10 through the CO₂ compression heat recovery circulation pipeline in the third heat exchange system 13.

When the air temperature is relatively low, such as in winter, the air passing through the residual pressure control system 9 may be heated through the hot air circulation pipeline and the heat exchanger.

In the present invention, the system and method of coupling a direct air carbon dioxide capture technology with a compressed air energy storage technology residual pressure and heat have the following beneficial effects:
(A) Compared with the existing processes, the system and method for coupling direct air carbon dioxide capture technology with a compressed air energy storage technology residual pressure and heat in the present invention can effectively utilize the residual pressure of the compressed air energy storage technology, significantly reduce the energy consumption of fans in the adsorption process, and achieve a reduction in the capture energy consumption and cost of the direct air carbon dioxide capture.
(B) The present invention can achieve the effective utilization of the renewable energy; both the direct air carbon dioxide capture system and the compressed air energy storage system can effectively utilize renewable electrical energy, reducing the impact of the renewable energy on the power grid and realizing the “peak load shaving and valley filling” of the power grid.
(C) The process of the present invention is novel; it can effectively utilize the air with stable pressure, humidity and temperature from the compressed air energy storage technology, reduce the influence of air humidity on the adsorption performance of adsorbents, and thus effectively reduce the capture energy consumption and cost of the direct air carbon dioxide capture system.
(D) The system and method for residual pressure and heat by coupling a direct air carbon dioxide capture technology with a compressed air energy storage technology in the present invention can achieve the capture of CO₂ by using only renewable electrical energy, and a carbon footprint of the entire process is very small, making it environmentally friendly.

### Example 1

The system and method for coupling a direct air carbon dioxide capture technology with a compressed air energy storage technology residual pressure and heat by as shown in FIG. 1 and FIG. 2 are adopted.

The direct air carbon dioxide capture system adopted a variable humidity regeneration adsorption mode. Heat required for regeneration water in the regeneration process was provided by heat released by a first heat exchange system of compressed air and a CO₂ compression device, which was stored in a normal temperature water tank. A required water temperature was between 20° C. and 60° C.

An operation procedure of the system and method for residual pressure and heat by coupling a direct air carbon dioxide capture technology with a compressed air energy storage technology in this example comprises:

A drying process: relatively humid air was passed through an air drying device to reduce its relative humidity from a higher level to a lower level, providing a dry gas source for the compressed air energy storage system and the direct air carbon dioxide capture system.

A compressed air energy storage process: as shown in FIG. 1, when renewable electric energy was abundant, high humidity air with humidity varying according to the weather was passed through the air drying device and the air induction device; then it entered the compressed air passage and was compressed to a pressure of 10 MPa in the air compression device; the high-pressure air was then stored in the compressed air storage tank; and the heat released in the compression process was carried away by water and stored in the residual heat centralized storage and control system,
wherein operation time of the compression step lasted for 5 hours-8 hours, and the air volume in the compressed air storage tank ranged from 1000 m³ to 10,000,000 m³.

The compressed air expansion process: when the renewable electric energy was in shortage, the high-pressure air stored in the compressed air storage tank had its temperature increased through the second heat exchange system; subsequently, the high-pressure air performed work within the expansion device, driving the generator to generate electricity, which enabled the electricity to be supplied to surrounding users or used for “peak filling” in the power grid; and, meanwhile, air with stable pressure, temperature, and humidity was discharged,
wherein the operation time of the power generation step by the expansion device lasted for 2 hours to 6 hours. Parameters of the air outlet of the expansion device were as follows: the humidity of the outlet air was within a range of 10% Relative Humidity (RH) to 60% RH, the outlet temperature was between 5° C. and 40° C., and the outlet pressure was within a range of 1.01 bar to 4.01 bar.

A CO₂ adsorption process: as shown in FIG. 1, when the renewable electric energy was abundant, dry air containing carbon dioxide (400 ppm) pumped by the air drying device and the air induction device was introduced into the CO₂ adsorption/desorption contactor through the first DAC air passage; adsorbents in the capture device adsorbs CO₂, and unabsorbed air (waste gas) was discharged from a ventilation outlet of the adsorption/desorption contactor; after ventilating for a certain period of time, adsorbents reached adsorption saturation, and its saturated adsorption capacity was approximately 0.2 mmol/g to 3 mmol/g;
when the renewable electric energy was in shortage, a power consuming device such as the air drying device, the air induction device, the air compression device, and the first heat exchange system turned off; air with stable pressure, temperature, and humidity after the power generation after expansion of the expansion device was directly connected to a CO₂ adsorption/desorption contactor through a second DAC air passage; adsorbents in the adsorption/regeneration contactor adsorbed CO₂, the unabsorbed air (waste gas) was discharged from the ventilation outlet of the adsorption/desorption contactor; and ventilation continues for a period of time until adsorbents reached adsorption saturation,
wherein the adsorption/desorption contactor device adopted a built-in adsorbent; adsorbents were in a form of particles, membranes, etc.; and the pressure drop inside the contactor was 300 Pa to 30,000 Pa.

A CO₂ desorption process: after adsorbents were saturated with adsorption, the adsorption/desorption fan, the air inlet, and the air outlet were closed; a vacuum pump was utilized to evacuate the adsorption/desorption contactor to a certain negative pressure; and then, an aqueous solution at a certain temperature from the residual heat centralized storage and control system was sprayed; and according to a principle of pressure and humidity swing regeneration, the desorption of CO₂ was accelerated,
wherein the temperature of the aqueous solution was 20° C. to 60° C.; adsorbents could be made of materials such as quaternized and quaternary phosphonated cellulose, activated carbon, molecular sieves, and metal-organic frameworks.

A CO₂ compression process: the CO₂ regenerated from the adsorption/regeneration contactor was compressed to a liquefied CO₂ state and stored in a CO₂ liquefaction tank; and the heat generated in a compression process was transferred to the residual heat centralized storage and control system through the third heat exchange system for storage.

### Example 2

The system and method for residual pressure and heat by coupling a direct air carbon dioxide capture technology with a compressed air energy storage technology as shown in FIG. 1 and FIG. 2 were adopted.

The direct air carbon dioxide capture system adopted a variable temperature regeneration adsorption mode. The heat required for regeneration steam in the regeneration process was provided by heat released by a first heat exchange system of compressed air and a CO₂ compression device, which was stored in a medium-temperature water tank and a high-temperature water tank.

An operation procedure of the system and method for coupling direct air carbon dioxide capture technology with compressed air energy storage technology residual pressure and heat in this example comprises:

A drying process: relatively humid air was passed through an air drying device to reduce its relative humidity to a lower level, providing a dry gas source for a compressed air energy storage system and a direct air carbon dioxide capture system.

A compressed air energy storage process: as shown in FIG. 1, when renewable electric energy was abundant, air with humidity varying according to the weather was passed through the air drying device and the air induction device; then it entered the compressed air passage and was compressed to the pressure of 10 MPa in the air compression device; the high-pressure air was then stored in the compressed air storage tank; and the heat released in the compression process was carried away by water and stored in the residual heat centralized storage and control system,
wherein operation time of the compression step lasted for 5 hours-8 hours, and the air volume in the compressed air storage tank ranged from 1,000 m³ to 10,000,000 m³.

A compressed air expansion process: a step of the expansion device for doing work and generating electricity; when the renewable electric energy was in shortage, the high-pressure air stored in the compressed air storage tank had its temperature increased through the second heat exchange system; subsequently, the high-pressure air performed work within the expansion device, driving the generator to generate electricity, which enabled the electricity to be supplied to surrounding users or used for “peak filling” in the power grid; and, meanwhile, air with stable pressure, temperature, and humidity was discharged, wherein the operation time of the power generation step by the expansion device lasted for 2 hours to 6 hours. Parameters of the air outlet of the expansion device were as follows: the humidity of the outlet air was within the range of 10% RH to 60% RH, the outlet temperature was between 5° C. and 40° C., and the outlet pressure was from 1.01 bar to 4.01 bar.

A CO₂ adsorption process: as shown in FIG. 1, when the renewable electric energy was abundant, dry air containing carbon dioxide (400 ppm) pumped by the air drying device and the air induction device was introduced into the CO₂ adsorption/desorption contactor through the first DAC air passage; adsorbents in the capture device adsorb CO₂, and unabsorbed air (waste gas) was discharged from a ventilation outlet of the adsorption/desorption contactor; after ventilating for a certain period of time, adsorbents reach adsorption saturation, and its saturated adsorption capacity was approximately 0.2 mmol/g to 5 mmol/g;
when the renewable electric energy was in shortage, a power consuming device such as the air drying device, the air induction device, the air compression device, and the first heat exchange system were turned off; air with stable pressure, temperature, and humidity after the power generation after expansion of the expansion device was directly connected to the CO₂ adsorption/desorption contactor through a second DAC air passage; adsorbents in the adsorption/regeneration contactor adsorbs CO₂, the unabsorbed air (waste gas) was discharged from the ventilation outlet of the adsorption/desorption contactor; and ventilation continued for a period of time until adsorbents reach adsorption saturation,
wherein the adsorption/desorption contactor device can adopt a built-in adsorbent; adsorbents can be a temperature-variable adsorbents such as amine-loaded molecular sieves, amine-loaded metal-organic frameworks, amine-loaded polymers, metal-organic frameworks, or amine-loaded activated carbon; adsorbents can be in a form of particles, membranes, etc.; and a pressure drop within the contactor was between 300 Pa and 30,000 Pa.

A CO₂ desorption process: after adsorbents were saturated with adsorption, the high-temperature steam stored in the residual heat centralized storage and control system was introduced into the adsorption/desorption contactor to realize the regeneration of adsorbents; the steam and CO₂ could be separated through a condenser, after which the CO₂ flows into the CO₂ compression device, and the steam was reheated in a cycle for reuse,
wherein the temperature range of the steam required by the adsorption/desorption contactor was 80° C. to 120° C.

A CO₂ compression process: the CO₂ regenerated from the adsorption/regeneration contactor was compressed to a liquefied CO₂ state and stored in a CO₂ liquefaction tank; and the heat generated in a compression process was transferred to the residual heat centralized storage and control system through the third heat exchange system for storage.

### Example 3

The system and method for residual pressure and heat by coupling a direct air carbon dioxide capture technology with a compressed air energy storage technology based on the example 1 carry out the following calculations:

I. The compressed air storage system with the gas storage volume of 1 million m³ in the compressed air storage tank was adopted. That is, the power generation capacity of the compression energy storage system was approximately 300 MW, which could be matched with the direct air carbon dioxide capture system with the capture capacity of approximately 50,000 tons per year.

It was assumed that the air volume under 10 MPa was approximately 120 times that under an atmospheric pressure;
expansion time of the expansion device of the compressed air energy storage system was 5 hours, and it discharges air with a stable temperature, pressure and humidity;
Annual adsorption time of the adsorption/desorption contactor of the direct air carbon dioxide capture system was 6,000 hours;
it was assumed that the content of CO₂ in the air was 400 ppm, and the content of the CO₂ in 1 m³ of air was 0.786 g/m³;
it was assumed that the capture rate of the adsorption/desorption contactor was 50%; and
then the annual capture amount was approximately 56,000 tons of CO₂ per year.

II. A stable residual pressure of the compression energy storage system could be utilized to save an energy consumption of a fan required for the pressure drop inside the adsorption/desorption contactor of the direct air carbon dioxide capture system, and the savings amount to 30% to 78% of the capture energy consumption.

At present, a regeneration energy consumption of direct air carbon dioxide capture without considering the energy consumption of fans was approximately 8 MJ/t-CO₂ per ton of CO₂.

It was assumed that the pressure drop of the adsorption/desorption contactor was 1000 Pa, the annual operation time of a fan pumping was 6000 hours, the annual air flow rate was 24,000,000 m³/hour of air, and the annual CO₂ capture amount was 56,000 tons. Through calculation, it could be obtained that the energy consumption of fans per ton of CO₂ captured by the direct air carbon dioxide capture system could be saved by approximately 14.5 MJ, that is, the energy consumption of fans that could be saved accounts for 66% of the capture energy consumption of the direct air carbon dioxide capture system.

When the pressure drop of the adsorption/desorption contactor was 500 Pa, the energy consumption of fans per ton of CO₂ captured by the direct air carbon dioxide capture system could be saved by approximately 7.3 MJ, that is, the energy consumption of fans that could be saved accounts for 48% of the capture energy consumption of the direct air carbon dioxide capture system.

When the pressure drop of the adsorption/desorption contactor was 2000 Pa, the energy consumption of fans per ton of CO₂ captured by the direct air carbon dioxide capture system could be saved by approximately 29 MJ, that is, the energy consumption of fans that could be saved accounts for 78% of the capture energy consumption of the direct air carbon dioxide capture system.

III. The air with stable humidity from the compression energy storage system could reduce the influence of air humidity fluctuations on the performance of adsorbents in the direct air carbon dioxide capture system, and reduce the capture energy consumption of the direct air carbon dioxide capture system, with the reduction range of up to 15% to 50%.

In the southern regions of China, the air humidity exceeds 60% for a considerable period of time each year, and in some regions, the humidity is even higher than 80%. Since the humidity has a significant impact on the humidity-variable adsorbent, when the relative humidity of the air exceeds 60% RH, the adsorption capacity of adsorbents is only 50% of that at a relative humidity of 20% RH, which greatly reduces the capture efficiency, causing the capture rate of the direct air carbon dioxide capture system to decline and the capture energy consumption of the direct air carbon dioxide capture system to double.

By utilizing the air source with stable humidity and stable pressure from the compressed air energy storage system, on the basis of reducing the energy consumption of fans, the impact of humidity on the direct air carbon dioxide capture system could be further significantly reduced, and the capture rate of the system could be increased by approximately 20% to 50%. Consequently, the capture energy consumption could be reduced within a range of 20% to 50%. Finally, the energy consumption of the direct air carbon dioxide capture system could be reduced to 4 MJ/t-CO₂ to 6.4 MJ/t-CO₂ per ton of CO₂.

In addition, it should be understood that after reading the above description of the present invention, those skilled in the art can make various changes or modifications to the present invention, and these equivalent forms also fall within the scope defined by the appended claims of this application.

1. A method of coupling direct air carbon dioxide capture technology with compressed air energy storage technology residual pressure and heat, characterized in matching a system of coupling direct air carbon dioxide capture technology with compressed air energy storage technology residual pressure and heat with renewable energy, wherein the system of coupling direct air carbon dioxide capture technology with compressed air energy storage technology residual pressure and heat with renewable energy comprises a compressed air energy storage system, a residual pressure control system (9), a residual heat centralized storage and control system (10), and a direct air carbon dioxide capture system, wherein
the compressed air energy storage system comprises an air drying device (1), an air induction device (2), an air compression device (3), a first heat exchange system (4), a compressed air storage tank (5), a second heat exchange system (6), an expansion device (7), and a generator (8) connected in sequence;
the direct air carbon dioxide capture system comprises an adsorption/desorption contactor (11), a CO₂ compression device (12), a third heat exchange system (13), and a CO₂ high-pressure liquefaction tank (14) connected in sequence;
an air inlet end of the residual pressure control system (9) is connected to an air outlet end of the air induction device (2) through a first direct air capture (DAC) air passage (18) and to an air outlet end of the expansion device (7) through a second DAC air passage (19); an air outlet end of the residual pressure control system (9) is connected to the adsorption/desorption contactor (11); and a heat exchanger (16) is provided inside the residual pressure control system (9); and
the residual heat centralized storage and control system (10) is connected to the first heat exchange system (4) through a first heat storage pipeline (20) to form an air compression heat recovery circulation pipeline, is connected to the second heat exchange system (6) through a first heat supply pipeline (21) to form a heated compressed air circulation pipeline, is connected to the adsorption/desorption contactor (11) through a second heat supply pipeline (22) to form a CO₂ desorption circulation pipeline, and is connected to the third heat exchange system (13) through a second heat storage pipeline (23) to form a CO₂ compression heat recovery circulation pipeline; and the residual heat centralized storage and control system (10) is connected to the heat exchanger (16) in the residual pressure control system (9) through a third heat supply pipeline to form a hot air circulation pipeline for regulating a temperature of air passing through the residual pressure control system (9);
the method comprising the following two operation modes:
operation mode 1: when the renewable energy is abundant, the compressed air energy storage system stores air; after the air enters the air drying device (1) and the air induction device (2), a part of air is compressed by the air compression device (3) and then stored in the compressed air storage tank (5), and the heat released in an air compression process is stored in the residual heat centralized storage and control system (10) through the air compression heat recovery circulation pipeline in the first heat exchange system (4); the other part of air enters the adsorption/desorption contactor (11) through the first DAC air passage (18) and the residual pressure control system (9), and is discharged after CO₂ is adsorbed and removed by adsorbents in the adsorption/desorption contactor (11); the second heat supply pipeline (22) provides humidity and/or temperature conditions required for adsorbents to desorb CO₂ in the adsorption/desorption contactor (11); the desorbed CO₂ is compressed by the CO₂ compression device (12) and then stored in the CO₂ high-pressure liquefaction tank (14); and heat released in a CO₂ compression process is stored in the residual heat centralized storage and control system (10) through the CO₂ compression heat recovery circulation pipeline in the third heat exchange system (13); and
operation mode 2: when the renewable energy is insufficient, compressed air stored in the compressed air storage tank (5) is heated by the second heat exchange system (6) and then enters the expansion device (7) to do work, which is used for the generator (8) to generate electricity; after doing work, air with a stable humidity, temperature and pressure enters the adsorption/desorption device (11) through the second DAC air passage (19) and the residual pressure control system (9), and is discharged after CO₂ is adsorbed and removed by an adsorbents in the adsorption/desorption contactor (11); the second heat supply pipeline (22) provides humidity and/or temperature conditions required for adsorbents to desorb CO₂ in the adsorption/desorption contactor (11); the desorbed CO₂ is compressed by the CO₂ compression device (12) and then stored in the CO₂ high-pressure liquefaction tank (14); and the heat released in a CO₂ compression process is stored in the residual heat centralized storage and control system (10) through the CO₂ compression heat recovery circulation pipeline in the third heat exchange system (13).

2. The method of coupling direct air carbon dioxide capture technology with compressed air energy storage technology residual pressure and heat according to claim 1, wherein heat recovered by the air compression heat recovery circulation pipeline and the CO₂ compression heat recovery circulation pipeline is supplied to the heated compressed air circulation pipeline, the CO₂ desorption circulation pipeline and the hot air circulation pipeline.

3. The method of coupling direct air carbon dioxide capture technology with compressed air energy storage technology residual pressure and heat according to claim 1, wherein the residual heat centralized storage and control system (10) comprises a normal-temperature heat storage tank, a medium-temperature heat storage tank and a high-temperature heat storage tank, which are used to receive and store the heat recovered by the air compression heat recovery circulation pipeline and the CO₂ compression heat recovery circulation pipeline, wherein
the temperature range of the normal-temperature heat storage tank is from 5° C. to 60° C., and the normal-temperature heat storage tank is connected to the third heat supply pipeline to provide a stable heat source for the residual pressure control system (9) and regulate the temperature of air required for direct air carbon dioxide adsorption;
a temperature range of the medium-temperature heat storage tank is 70° C. to 150° C., and the medium-temperature heat storage tank is connected to the first heat supply pipeline (21) and the second heat supply pipeline (22) to provide heat required for adsorbents regeneration of the adsorption/desorption contactor (11) and the second heat exchange system (6); and
a temperature range of the high-temperature heat storage tank is 160° C. to 250° C., and the high-temperature heat storage tank is connected to the first heat supply pipeline (21) to provide heat for the second heat exchange system (6).

4. The method of coupling direct air carbon dioxide capture technology with compressed air energy storage technology residual pressure and heat according to claim 1, wherein medium in the first heat supply pipeline (21), the second heat supply pipeline (22) and the third heat supply pipeline is each independently at least one of air, water, steam and oil.

5. The method of coupling direct air carbon dioxide capture technology with compressed air energy storage technology residual pressure and heat according to claim 1, wherein a pressure relief device (15) and an air distribution device (17) are also provided inside the residual pressure control system (9) to match the air pressure and volume with the adsorption/desorption contactor (11).

6. The method of coupling direct air carbon dioxide capture technology with a compressed air energy storage technology residual pressure and heat according to claim 1, wherein gas parameters at the outlet end of the residual pressure control system (9) comprise: a pressure range of 1.01 bar to 4.01 bar, a humidity range of 10% RH to 60% RH, and a temperature range of 5° C. to 40° C.

7. The method of coupling direct air carbon dioxide capture technology with a compressed air energy storage technology residual pressure and heat according to claim 1, wherein the CO₂ adsorbents in the adsorption/desorption contactor (11) is at least one of activated carbon, molecular sieve, solid-state amine, quaternary ammonium compounds, and metal-organic frameworks, and the regeneration manner thereof comprises temperature swing adsorption, humidity swing adsorption, pressure swing adsorption, or electrochemical regeneration.

8. (canceled)

9. The method of coupling direct air carbon dioxide capture technology with compressed air energy storage technology residual pressure and heat according to claim 1, wherein the air passing through the residual pressure control system (9) is heated through the hot air circulation pipeline and the heat exchanger (16).
